(19) United States
(12) Patent Application Publication
(10) Pub. No.: US 2008/0105367 A1
(43) Pub. Date: May 8, 2008

(54) METHODS FOR PRODUCING A LABEL HAVING A SUBSTANTIALLY TWO DIMENSIONAL IMAGE ON A SURFACE HAVING A TOPOGRAPHICAL TEXTURE, AND A LABEL BEARING SUCH AN IMAGE

(75) Inventors: Wayne Ernest Conrad, Hampton (CA); Nina Kanevsky Conrad, Hampton (CA); Helmut Horst G. Conrad, Hampton (CA); Ron Hills, Hampton (CA); Harvey Kalef, Richmond Hill (CA); Alan Litwack, (US)

Correspondence Address: BERESKIN AND PARR, 40 KING STREET WEST, BOX 401, TORONTO, ON, M5H 3Y2, omitted

(73) Assignee: 2089275 ONTARIO LTD., Richmond Hill (CA)

(21) Appl. No.: 11/774,815

(22) Filed: Jul. 9, 2007

Related U.S. Application Data
(63) Continuation-in-part of application No. 11/571,317.
Application No. 11/571,317 is a continuation-in-part of application No. 11/571,300.
Application No. 11/571,300 is a continuation-in-part of application No. 11/571,323.
(60) Provisional application No. 60/610,170, filed on Sep. 16, 2004.
(60) Provisional application No. 60/621,669, filed on Oct. 26, 2004.
(60) Provisional application No. 60/654,937, filed on Feb. 23, 2005.
(60) Provisional application No. 60/654,938, filed on Feb. 23, 2005.
(60) Provisional application No. 60/654,941, filed on Feb. 23, 2005.
(60) Provisional application No. 60/654,936, filed on Feb. 23, 2005.
(60) Provisional application No. 60/624,547, filed on Nov. 4, 2004.

(51) Int. Cl. B29C 69/00; B32B 1/02; B32B 7/12; B32B 38/14

(52) U.S. Cl. 156/242; 156/277; 428/34.1; 428/41.8; 428/99

(57) ABSTRACT

A method of labeling a distributable comprises (a) providing a plastic substrate; (b) providing a substantially two dimensional image of a label on the plastic substrate; (c) providing a topographical texture corresponding to at least one feature of the two dimensional image, such that the at least one feature of the image varies in a third dimension, orthogonal to the two dimensions of the image; and, (d) attaching the plastic substrate to an outer surface of the distributable. A label for a distributable is also provided.

### RELATED APPLICATIONS

This application is a (1) continuation-in-part of U.S. Utility patent application Ser. No. 11/571,317 filed on Dec. 27, 2006, which is a national phase application of International Application No. PCT/CA2005/001415 filed Sep. 16, 2005, which claims the benefit of U.S. Provisional Patent Application No. 60/610,170 filed on Sep. 16, 2004, and (2) a continuation-in-part of U.S. Utility patent application Ser. No. 11/571,300 filed on Dec. 27, 2006, which is a national phase application of International Application No. PCT/CA2005/001578 filed on Oct. 18, 2005, and (3) a continuation-in-part of U.S. Utility patent application Ser. No. 11/571,323 filed on Dec. 27, 2006, which is a national phase application of International Application No. PCT/CA2005/001579 filed Oct. 18, 2005, which claims the benefit of U.S. Provisional Patent Application Nos. 60/621,669 filed on Oct. 26, 2004; 60/624,547 filed on Nov. 4, 2004; 60/654,936 filed on Feb. 23, 2005; 60/654,941 filed on Feb. 23, 2005; 60/654,938 filed on Feb. 23, 2005; and 60/654,937 filed on Feb. 23, 2005 the entire contents of all of which are hereby incorporated by reference.

### FIELD OF THE INVENTION

This invention relates to methods for using a deformable plastic substrate, such as polystyrene or polyvinylchloride (PVC), to produce a label, such as for a bottle, which has three-dimensional image.

### BACKGROUND OF THE INVENTION

It is known to produce art reproductions by printing an image on a thermoformable sheet and subsequently subjecting the thermoformable sheet to vacuum molding to provide topography in the image surface thereof. See for example U.S. Pat. Nos. 5,958,470 and 5,904,962. In addition, other limited uses of artwork reproduced on a thermoformable sheet have been proposed in U.S. Pat. No. 5,904,962.

### SUMMARY OF THE INVENTION

In accordance with the instant invention, improved labels are provided that are made from plastic deformable substrates. The substrate has a two-dimensional image. For example, an image may be provided on the front or image bearing face of the substrate, such as by being printed thereon. The substrate is treated, such as by being subjected to pressure and/or vacuum forming, to create a three-dimensional representation or topography corresponding to, e.g., an original piece of art, a design, an advertisement or any other desired image.

The label may be secured to all or a portion of the outside of a distributable (e.g., the packaging of a product or a container of a product, e.g. a wine bottle or the product itself). The substrate may be at least translucent and, may, is transparent (i.e., is formed from a clear plastic which may have an image printed thereon and a topography provided therein). Accordingly, part of the product may be visible through the image substrate.

Alternately or in addition, a thermoformable sheet may be secured to a container or other distributable by associating the thermoformable sheet, which has an image and a three dimensional profile produced therein, with paper or other sheets known in the art, which are used in preparing labels (a mounting substrate). Accordingly, the mounting substrate is used to secure the image substrate into the container. The mounting substrate may be a sheet of cardboard, plastic or the like. Accordingly, in accordance with this invention, it is possible to mass produce labels that have images provided therein which are printed on thermoformable plastic and have a relief or topography provided in the thermoformable sheet (i.e. a three dimensional image). By using a mounting substrate, it is possible to incorporate three-dimensional labels or the like onto containers using existing manufacturing techniques.

Preferably, the image substrate is attached to the mounting substrate prior to the mounting substrate being provided on the distributable. However, it will be appreciated that in an alternate embodiment, the image substrate may be affixed to the mounting substrate subsequent to the mounting substrate being provided on the distributable.

In such an embodiment, the image substrate and the mounting substrate are a composite work that together forms a all or a portion of the label of a product. A further advantage of this aspect of the instant invention is that, by using a mounting substrate, both sides of the panel or portion may be utilized to contain articles, images or any other material routinely provided on surfaces of a container. For example, the image-bearing surface of the image substrate may have one or more of a picture, design, text or the like provided therein. The opposite or rear surface of the image substrate contains the negative version of the topography provided in the image substrate and is accordingly less desirable for use. For example, it is less desirable to have text on the negative image side of an image substrate as the text may be difficult to read as the surface has the negative topography of the front, image, bearing surface. The side of the mounting substrate that is not affixed to the image substrate may have text, pictures or the like provided thereon. Accordingly, both sides of a label may be utilized.

The image substrate may be removably affixed to the mounting substrate, such as by a releasable adhesive, which adhesives are known in the art. Alternately, or in addition, the mounting substrate and the image substrate together may be removably affixed to the container

In accordance with the instant invention, there is provided a method of labeling a distributable comprising
a) providing a plastic substrate;
b) providing a substantially two dimensional image of a label on the plastic substrate;
c) providing a topographical texture corresponding to at least one feature of the two dimensional image, such that the at least one feature of the image varies in a third dimension, orthogonal to the two dimensions of the image; and
d) attaching the plastic substrate to an outer surface of the distributable.

In one embodiment, the method further comprises selecting a distributable that has a sealable cavity for containing a liquid.

In another embodiment, the method further comprises selecting a bottle comprising an opening sealable by a cork or cap as the distributable.

In another embodiment, the method further comprises selecting a bottle that is made of glass or plastic and that has an opening sealable by a cork or cap as the distributable.

In another embodiment, the method further comprises filling the sealable cavity with an alcoholic beverage or a fragrance.

In another embodiment, the method further comprises molding the plastic substrate to provide the topographical texture.

In another embodiment, the method further comprises selecting a thermoformable plastic as the plastic substrate.

In another embodiment, the method further comprises selecting one or more of poly vinyl chloride, ethylene vinyl acetate, polystyrene, neoprene, polyethylene, ABS, and PET as the plastic substrate.

In accordance with the instant invention, there is provided a distributable assembly comprising
(a) a distributable having an outer surface having a profile; and,
(b) a plastic label for attaching to the distributable, the label having
   (i) a substantially two-dimensional image printed on the label;
   (ii) a topographical texture corresponding to at least one feature of the two dimensional image such that the at least one feature of the image varies in a third dimension, orthogonal to the two dimensions of the image; and
   (iii) an attachment for attaching the label to the distributable.

In one embodiment, the label is made of a thermoformable plastic.

In another embodiment, the label is made of one or more of poly vinyl chloride, ethylene vinyl acetate, polystyrene, neoprene, polyethylene, ABS, and PET.

In another embodiment, the label is molded to provide the topographical texture.

In another embodiment, the label is provided with a profile to match the profile of the distributable.

In another embodiment, the label is provided with a backing layer that does not have a topography.

### BRIEF DESCRIPTION OF THE DRAWINGS

These and other advantages of the instant invention will be more fully and completely understood in association with the following description of the preferred embodiments of the invention in which:

FIGS. 1A, 1B, and 1C are top plan and perspective views of a label and uses of the label in accordance with this invention;

FIG. 1D is an enlarged view of a side elevation view of the label of FIG. 1A;

FIG. 2 is an exploded view of a composite work according to an embodiment of the instant invention; and,

FIG. 2A is a side view of the exploded view of the composite work of FIG. 2.

### DETAILED DESCRIPTION OF THE INVENTION

In accordance with this invention, a plastic substrate is used that has a two dimensional image and a three dimensional topography. The substrate is used to form at least part of, and preferably all of, a label. The label may be a affixed to a product itself or a container or packaging of the product.

Providing a label with a three-dimensional relief and/or topographical texture thereon enhances the attractiveness of the container, which may enhance the likelihood that the product may be purchased by a customer. Moreover, using a plastic substrate, such as thermoformable plastic, may enhance the durability of the label so that during transportation and display, the label is not marred and is legible. In addition, the label may be used to express to a potential customer that a product is an upscale product, which may aid in sales.

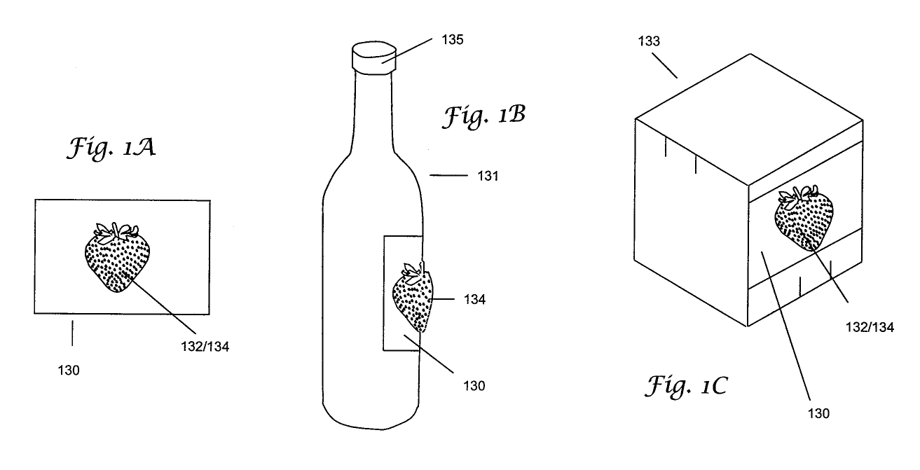

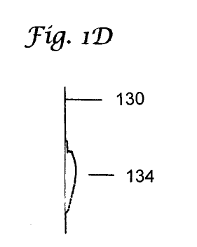

In one embodiment, as exemplified in FIGS. 1B and 1C, all of label 130 consists of or includes a plastic substrate with a three dimensional relief pattern corresponding to a two dimensional image. It will also be appreciated that any portion not made of a plastic substrate having a topography may be made from any materials known in the label art, such as a cellulose or a metalized substrate.

The substrate is preferably a preferably a thermoformable plastic. The thermoformable plastic is preferably one or more of poly vinyl chloride (PVC), ethylene vinyl acetate (EVA), polystyrene, neoprene, polyethylene, ABS, PET, and, more preferably, is EVA, PVC or polystyrene and, most preferably, is polystyrene. One advantage of the use of neoprene is that neoprene may be reversibly deformable and, accordingly, can be reused in the process. If the substrate is an irreversibly deformable thermoplastic such as polystyrene, then the thermoformable plastic may be recycled by grinding the used substrate as is known in the art.

The plastic substrate may have a thickness from 0.002-0.100 inches, preferably from 0.003-0.025 inches, more preferably from 0.006-0.012 inches.

The portion of the substrate on which the three-dimensional image is provided, the image bearing portion, may be part or all of the substrate. The image may be a two-dimensional printed image (e.g., it may be an image which is printed by lithography or any other printing or image reproduction means known in the gift container and printing arts). The image may be provided on the substrate utilizing any method known in the art, including one or more of offset lithography, silk screening, spray coating, ink jet printing or dye simulation printing.

The substrate is treated or formed, preferably after the two-dimensional image is printed on the substrate, to have a three-dimensional image or texture provided therein. This results in the production of a relief pattern or topography corresponding to part or all of the printed image thereby resulting in a three-dimensional image. The texturing of the substrate may be prepared by pressure forming, vacuum forming, pressure and vacuum forming, embossing, or applying a variable mechanical force to the substrate so as to produce a plurality of depths in the Z dimension. The variable mechanical force may be produced by a printing head, such as a dot matrix printing head, a daisy wheel printing head, by a plurality of pins or an eclectic deformable LCD whereby a computer signal will result in a physical member contacting and depressing the substrate at different locations. Preferably, the substrate is prepared by pressure and/or vacuum forming. It will be appreciated that the actual method by which the image and the topography are formed in the substrate does not comprise part of this invention and any such method known in the art may be utilized.

The image-bearing surface 20 of the substrate has an image provided therein. The image may be a two dimensional image, which may be prepared by printing an image on a thin plastic sheet. The topography may be prepared by preparing a mold that contains a female version of a three dimensional topography corresponding to the image and subjecting the substrate to vacuum and/or a pressure molding to form a male version of the topography in the substrate aligned with the two dimensional printed image. Preferably, image bearing surface 20 is prepared by printing a two dimensional image on image bearing surface 20 and then forming a three dimensional image (a relief pattern) matching the image printed on image bearing surface 20.

Prior to the substrate being subjected to any of the forgoing processes, the rigidity of the substrate may be temporarily reduced such as by increasing the temperature of the substrate or the addition of a chemical additive whose effect or presence is transient. For example, polystyrene, poly vinyl chloride or ABS may be exposed to methyl ethyl ketone (MEK). The MEK results in the thermo-formable plastic temporarily softening thereby enhancing the molding operation.

Such processes and substrates are described in co-pending United States patent application no. U.S. Utility patent application Ser. No. 11/571,323 and U.S. patent application Ser. No. 11/571,300, the disclosures of which are incorporated herein by reference.

It will also be appreciated that the image provided on the substrate need not be an artwork but may be of any design. For example, the image may be a design, e.g., an abstract design, photograph, machine produced art or reproduction for an advertisement, a photographic likeness with three dimensional relief to more closely simulate real life or any other material used on labels.

Referring to FIG. 1A there is shown a label 130 made from a substrate with a two-dimensional image 132 of a berry provided thereon with a three-dimensional topographical texture 134 formed over the image 132, which collectively may be referred to as a textured image 132/134. The topographical texture 134 aligns over the image 132 and corresponds to at least one feature of the image 132. It will be appreciated that textured image 132/134 may be provided on the label 130 using any means known in the art and/or described herein. The substrate may have the shape of any label known in the art, although only a rectangular shaped label is shown for illustrative purposes in FIG. 1A.

Therefore, label 130 is formed or treated to provide a three-dimensional relief or topographical texture 134 corresponding to the image 132 provided thereon, such that at least one specific feature of the image 132 provided on the label 130 varies in a third dimension orthogonal to the two dimensions of the image 132. That is, the topographical texture 134 provided in the label 130 aligns with the two-dimensional image 132 thereon, such that the texture 134 corresponds to at least one feature of the two-dimensional image 132.

For example, referring to FIG. 1A, there is shown a plan view of a label 130 with a three-dimensional topographical texture 134 formed over the two-dimensional image 132 of a berry provided thereon. This is further shown in FIG. 1D, which illustrates a cross sectional view of the label 130 after the label 130 (made from the substrate) is provided with a three-dimensional topographical texture 134 corresponding to the two dimensional image of the berry 132 thereon. An example of a topographical texture is a three-dimensional shape of the berry. Moreover, additional three-dimensional textured details of the berry may also be provided in the substrate. For example the seeds of the berry on its skin (not shown) may be given a topographical texture to distinguish them from surrounding portions of the berry. Thus, the three dimensional topographical texture 134 may have a plurality of three-dimensional depths so as to simulate the real life texture and relief of the object portrayed in the image 132. Further, preferably, the scaling of the texture varies. For example, if the berry contains seeds, then the seeds may have a proportionately greater variation in the Z dimension then the berry itself. Accordingly, the ratio of the thickness of the seeds in the textured image compared to the actual thickness of a seed, may be greater than the thickness of the berry in the textured image compared to the actual thickness of a berry.

The design may be an actual object, such as a berry. The scale factor that is used for the length and width of the two dimensional reproduction of the object (i.e. the ratio of the length and width of an actual berry compared to the length and width of the image of the berry on the substrate) is preferably scaled at a different scale to the depth of the object (i.e. the ratio of the depth of an actual berry compared to the depth of the image of the berry on the substrate). For example, the depth of the textured reproduction in the Z dimension may be scaled at a substantially reduced scale compared to the scaling utilized for the X and Y dimensions. In such a case, the substrate has a bold appearance and will attract the attention of the person but will be able to be contained on a substrate.

As another example, the label 130 may be treated or formed such that only certain objects or aspects of the substantially two-dimensional image 132 have a corresponding three-dimensional topographical texture 134 provided therein, while the remaining portions of the image remain substantially two-dimensional. For example, the image provided on the substrate may be a human wearing a bathing suit and only the portion of the image depicting a bathing suit may have a corresponding three-dimensional topographical texture provided in the substrate (not shown). For example, the texture and natural shape of the bathing suit, such as the ripples in the bathing suit fabric and the curves of the underlying human body may be formed into the label 130 as the topographical texture while the rest of the label 130 (and by extension the image thereon) remains substantially two-dimensional.

Moreover, topographical texture 134 formed on the label 130 is not limited to corresponding to three-dimensional features of a two-dimensional image 132 and may correspond to any image, text, or design typically. However, for simplicity of explanation the topographical texture 134 is described in relation to three-dimensional features of a two-dimensional image 132.

It will be appreciated that any of the various methods and configurations known in the art and/or described herein for forming a label 130 may be utilized. It will be appreciated that the printing and forming operations preferably occur prior to the panel or panels being formed, i.e., an expanse of the substrate is processed to produce the textured image and the panel(s) are then separated from the expanse of material.

The label 130 may then be secured to a product or container. The means utilized to secure the label 130 to the product or container may be any such suitable means known in the art, such as using an adhesive or releasable adhesive. The container may be made of a wide variety of materials such as glass, metal, plastic or the like and have the configuration of any container known in the art. Preferably, the container is a container for a liquid or a granular solid and/or at least a portion of the container on which the label is provided is non-planar and, preferably, rounded.

For example, FIG. 1B, illustrates the label 130 secured to a container 131 or more generally a sealable cavity for containing a liquid and/or a solid. The container 131 has an opening to receive the fluid or product, which may be resealable (e.g., such as by a screw cap, cork or other sealing member known in the bottling arts). For example, the product to which the label 130 relates may a container for an alcoholic beverage such as wine or a fragrance, such as perfume. The wine may be poured into the container 131 through the opening and the container 131 may then be sealed using a cap or cork 135.

Label 130 is preferably configured so that it may be secured to a non-planar surface of a product or container, such as a bottle or other liquid container with a round surface (e.g., it may have the same curvature or profile as the surface to which is to be applied) or packaging of a product. This configuration may be provided when the topography is provided in the label 130 (e.g., during a molding operation) or in a subsequent operation. Accordingly, when the label 130 is to be applied to a surface, it already has a configuration that conforms with the of the surface on which it is to be mounted. Although shown to cover only a small portion of the container 131, it will be appreciated that the label 130 may cover all or part of the container 131. Moreover, the substrate used to make the label may be translucent or transparent, so that the textured image 132/134 provided therein is the predominantly visible portion of the label 130.

It will be appreciated that the container to which the label 130 is secured may be any container known in the art. As another example, FIG. 1C illustrates the label 130 affixed to a container box 133, for an object such as a gift box or a box for the retail display and sale of a product, e.g., perfume. Accordingly, the label 130 may also be secured to a planar surface of a product or container. It will be appreciated that the above-described embodiments of containers and packaging are exemplary only, and the container or packaging may have the shape of any suitable container or packaging known in the art.

In some embodiments, the label 130 may have a backing layer secured to the reverse side (i.e. the side that does not contain the textured image). The backing layer may be made of any suitable material known in the art or described herein, and may be referred to as a mounting substrate. The side of backing layer that is not secured to the label may provide means for securing the label 130 to a container or packaging. For example the reverse side of the backing layer may contain an adhesive or a releasable adhesive. A backing layer may be desirable as a flat or adhesive surface on the rear side of the label 130 and will facilitate securing the label 130 to a container.

As a further option, a cover sheet may also be utilized. As the label 130 contains a textured image 132/134, cover sheet may be provided to enhance the durability of the label 130 and textured image 132/134. For example, cover sheet may be a thin plastic sheet having substantially the same shape and dimensions as label 130, and may be secured over the side of the label 130 containing the image 132 by any means known in the art. The cover sheet may have the same topographical texture 134 formed therein, so that when the cover sheet is placed over the label 130 the topographical texture 134 on each align.

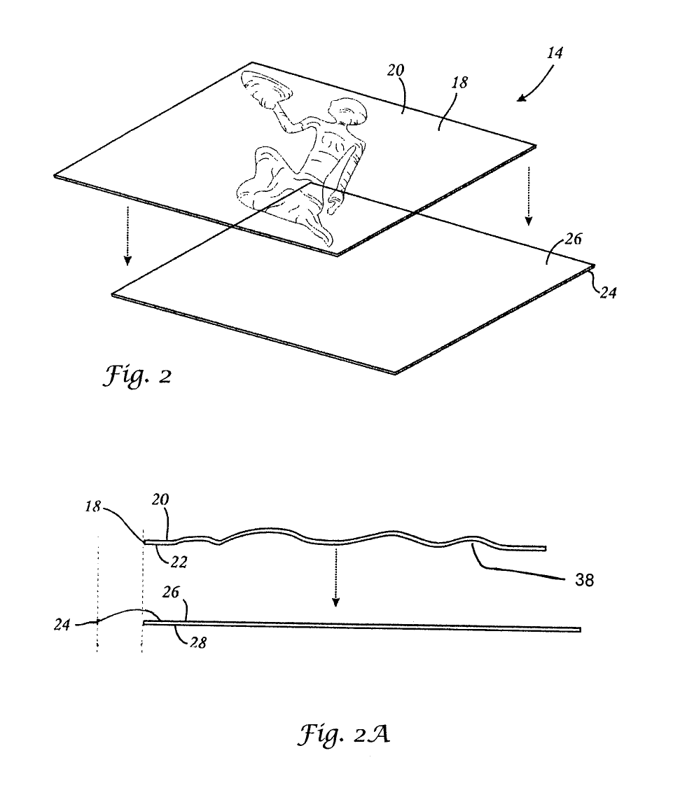

Accordingly, as exemplified in FIG. 2, in some embodiments, a backing layer or mounting substrate 24 may be affixed to the reverse side of the textured plastic substrate and/or the depressions 38 in the reverse side filled to, e.g., provide additional support or rigidity of label 130 or conceal the negative version of the textured image on rear surface 22. The backing layer may be constructed from any suitable material, such as plastic, cardboard, paper mache or any other material described herein in relation to the mounting substrate. The backing layer is preferably formed from a plastic or cellulose substrate.

The underlying backing layer may have substantially the same shape and size as the label such that the backing layer covers substantially all of the rear surface 22 of label 130, or may cover only part of the reverse surface (e.g., only the part with the texture provided therein). In other embodiments, the label may have a different shape then the backing layer. For example, the backing layer may only overlie the portion of label 130 with textured image 134.

Optional mounting substrate 24 may be any material suitable for receiving image substrate 18, i.e. the substrate with the textured image 134. Mounting substrate 24 may be any substrate suitable for securing label 130 (image substrate 18) to a container or packaging. Preferably, mounting substrate 24 is cellulose based and, more preferably, is paper. It will be appreciated that mounting substrate 24 may be 8 to 100 pound weight paper.

Mounting substrate 24 is preferably planar (i.e., the substrate extends in the X, Y planes) as shown in FIGS. 2 and 2A or it may be curved, and has a rear surface 28 which may have text or other material, e.g. a design, printed thereon in known fashion. Mounting surface 26 is secured to image substrate 18 by any means known in the art. For example, rear surface 22 of substrate 18 may be secured to mounting surface 26 such as by means of an adhesive, such as 3M Fastbond™ or a hot melt glue such as HB Fuller 1138™. In an alternate embodiment, it will be appreciated that rear surface 22 may be removably affixed to mounting surface 26 such as by means of a releasable adhesive, such as guar gum based adhesive.

In operation, each of image substrate 18 and mounting substrate 24 are preferably individually prepared. For example, a three dimensional image may be formed in image substrate 18 and text may be printed on viewable or rear surface 28 of mounting substrate 24. The substrates may then be associated together to form composite work 14 and composite work 14 may then be applied to a product, container or packaging. Alternately, it will be appreciated that image substrate may be secured to mounting substrate 24 after mounting substrate has been applied to a product, container or packaging.

Due to the forming process, depressions 38 are formed in rear surface 22 of image substrate 18 (see FIG. 2). These depressions form the negative image of the topography formed in image bearing surface 20. In order to enhance the durability of image substrate 18, depressions 38 may be filled, such as by filling depressions 38 with plaster, silicone, epoxy, or other, preferably non shrinking, filler materials. Accordingly, essentially no hollow spaces may be provided between rear surface 22 of image substrate 18 and a mounting substrate 24. It will be appreciated that in a particularly preferred embodiment, depressions 38 may be filled and cover sheet 36 may be provided. It will be appreciated that these options may be used singularly or in combination with any embodiment set out herein and with any embodiment.

Although the substrates are generally described herein as being flat, i.e. extending only in the X and Y dimensions, it will be appreciated that one or more panels or portions may be curved or of an alternate configuration. In such embodiments, the three-dimensional topographical texture formed therein may then vary orthogonal to a line tangent to the substrate at a given position, as will be understood by those skilled in the art.

It will be appreciated that various modifications and additions may be made to the embodiments disclosed herein and each are in the scope of the following claims. It will be appreciated that any of the embodiments set out herein, or preferences for any embodiments, may be used in conjunction with any other embodiment or optional preferences.

1. A method of labeling a distributable comprising
a) providing a plastic substrate;
b) providing a substantially two dimensional image of a label on the plastic substrate;
c) providing a topographical texture corresponding to at least one feature of the two dimensional image, such that the at least one feature of the image varies in a third dimension, orthogonal to the two dimensions of the image; and
d) attaching the plastic substrate an outer surface of the distributable.

2. The method as defined in claim 1 further comprising selecting a distributable that has a sealable cavity for containing a liquid.

3. The method as defined in claim 2 further comprising selecting a bottle comprising an opening sealable by a cork or cap as the distributable.

4. The method as defined in claim 2 further comprising selecting a bottle that is made of glass or plastic and that has an opening sealable by a cork or cap as the distributable.

5. The method as defined in claim 2 further comprising filling the sealable cavity with an alcoholic beverage or a fragrance.

6. The method as defined in claim 1 further comprising selecting the distributable from the group consisting of packaging of a product, a container of a product and a product itself.

7. The method as defined in claim 1 wherein step (c) comprises molding the plastic substrate to provide the topographical texture.

8. The method as defined in claim 1 further comprising selecting a thermoformable plastic as the plastic substrate.

9. The method as defined in claim 1 further comprising selecting one or more of poly vinyl chloride, ethylene vinyl acetate, polystyrene, neoprene, polyethylene, ABS, and PET as the plastic substrate.

10. A distributable assembly comprising
(a) a distributable having an outer surface having a profile; and,
(b) a plastic label for attaching to the distributable, the label having
(i) a substantially two-dimensional image printed on the label;
(ii) a topographical texture corresponding to at least one feature of the two dimensional image such that the at least one feature of the image varies in a third dimension, orthogonal to the two dimensions of the image; and
(iii) an attachment for attaching the label to the distributable.

11. The distributable assembly as defined in claim 10 wherein the label is made of a thermoformable plastic.

12. The distributable assembly as defined in claim 10 wherein the label is made of one or more of poly vinyl chloride, ethylene vinyl acetate, polystyrene, neoprene, polyethylene, ABS, and PET.

13. The distributable assembly as defined in claim 10 wherein the label is molded to provide the topographical texture.

14. The distributable assembly as defined in claim 10 wherein the label is provided with a profile to match the profile of the distributable.

15. The distributable assembly as defined in claim 10 wherein the label is provided with a backing layer that does not have a topography.

16. The distributable assembly as defined in claim 10 wherein the distributable is selected from the group consisting of packaging of a product, a container of a product and a product itself.
